(19) United States
(12) Patent Application Publication
(10) Pub. No.: US 2012/0101879 A1
(43) Pub. Date: Apr. 26, 2012

(54) Faucet system and advertising method

(76) Inventors: Cory Galakatos, Scottsdale, AZ (US); Scott Brown, Scottsdale, AZ (US)

(21) Appl. No.: 13/373,266

(22) Filed: Nov. 9, 2011

Related U.S. Application Data
(63) Continuation-in-part of application No. 12/383,707, filed on Mar. 27, 2009, now abandoned.

(51) Int. Cl. G06Q 30/02; G06Q 90/00; F16K 21/00

(52) U.S. Cl. 705/14.4; 137/801; 705/500

(57) ABSTRACT

A faucet system including: a first set of faucet components including at least a water regulating device and a water dispensing device, wherein the water regulating device and the water dispensing device include advertising indicia of a first theme; a second set of faucet components including at least a water regulating device and a water dispensing device, wherein the water regulating device and the water wherein the first and second set of faucet components are configured to be interchangeably connected to a base.

This application claims priority based upon previously file U.S. application Ser. No. 12/383,707, filed on Mar. 27, 2009, the contents of which are hereby incorporated by reference.

### TECHNICAL FIELD

The present disclosure relates to an advertising faucet system and related method of advertising.

### BACKGROUND

Faucets used to regulate and dispense water are typically mounted to a sanitary structure such as a sink, washbasin, bathtub, or the like. Faucet systems general include dispensing components that direct the flow of the water and regulating components that control the flow rate and temperature of the water being dispensed. The dispensing components and regulating components can be separately mounted to the sanitary structure or they can be integrally mounted to the sanitary structure as a single unit.

Most of the prior developments in faucet systems relates to improving the overall reliability and water dispensing and regulating capabilities of such systems. Advancements have also been made relating to the installation and maintenance of such systems.

### SUMMARY

The present disclosure provides a faucet system that is configured for advertising/promotional purposes. A related method of advertising using faucets is also provided. In some embodiments the faucet system of the present disclosure share features of quick connect faucet systems. One quick connect faucet system is described in US 20006/0185076 entitled, Faucet Assembly with Integral Water Supply Shut-Off Valve, filed on Feb. 23, 2006, which is herein incorporated by reference in its entirety. Another quick connect faucet systems is described in U.S. Pat. No. 6,328,059 entitled, Top Mounted Faucet Assembly, fled on Mar. 22, 2000, which is also herein incorporate by reference in its entirety.

The faucet systems and methods of the present disclosure are particularly well suited for use in restrooms in commercial buildings such as hotels, sport stadiums, convention centers, restaurants, etc. In one specific embodiment, the method of advertising includes providing faucet components for a hotel where the shape of the faucet components fall within a theme (e.g., baseball, NASCAR, etc.) and wherein the components can be switched out depending on who is scheduled to stay in the room (e.g., a professional baseball team, race fans, etc.). Many other alternative embodiments are also provided which are described in detail below.

In another specific embodiment of the faucet systems and methods of the present disclosure, the method of advertising includes providing faucet components where the faucet include an integral electronic display system. The preferred electronic display system is a Liquid Crystal Display (LCD) or other equivalent screen. The screen is electronically connected to a microprocessor system. Advertising stored in the microprocessor system can be displayed in the faucet screen on a predetermined schedule.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE FIGURES

FIG. 1 show a faucet system according to an embodiment of the present disclosure, wherein some of the faucet components embody advertising indicia.

FIGS. 2-7 further illustrate an alternative embodiment of the present disclosure.

FIG. 9 shows an exploded view of the faucet system according to an embodiment of the present disclosure, wherein some of the faucet components are an audio visual display.

FIG. 10 shows a perspective view of the faucet system according to an embodiment of the present disclosure, wherein some of the faucet components are an audio visual display.

FIG. 11 is a flowchart demonstrating the flow of water, power and information throughout the local faucet system

FIG. 12 is a flowchart illustrating the flow of information from user input, through the master network and to the local faucet computer.

FIG. 13 is a flowchart illustrating the process of transmitting content out of storage to displaying that content to the user.

### DETAILED DESCRIPTION

Traditional mediums of advertisements have been billboards, newspapers, and television. There have been developments in these traditional advertisement mediums. For example, billboard now often convert to show more than one image or even include video. However, recently new mediums and associated methods for advertisement have also been developed. For example, see U.S. Pat. No. 6,404,519 to McAbee, which discloses a method of advertising on the windshield of a motor vehicle, U.S. Pat. No. 7,195,155 to Garberg et al., which discloses a method of advertising on a shopping cart, and U.S. Pat. No. 6,494,210 to Mams, which disclosure relates to yet another new medium and associated method of advertising involving a mouth guard.

Faucets have been traditionally understood as being functional items that may have some decorative qualities. The concept described herein of using faucet components for advertising challenges this generally accepted paradigm.

Faucets embody some of the most important characteristics of a good medium for advertising. The functional aspect of a faucet (water delivery) draws people to the faucet and holds them captive for periods of time that are typically long enough for the people using the faucet to recognize the advertisement thereon.

According to an embodiment of the present disclosure the faucets in public or a commercial bathroom can be used as advertisement space. For example, in an embodiment of the present disclosure a restaurant could receive advertising revenue from a company that has its logo, mascot, or other indicia represented on the faucets in the bathroom of the restaurant.

In another embodiment, the faucets can be used generally for promotion as well. For example, the bathrooms in a baseball stadium can include faucets that have the mascot, logos, gear relating to baseball, or even indicia relating to the particular teams that are playing in the stadium on a particular night. In some embodiment, a stadium may include a number of different theme faucets that can be switched out depending on the event that is being hosted. For example, if the stadium is reconfigured to host a monster truck show, the faucets therein can be switched out to be representative of monster trucks or truck accessories (i.e., trucks, wheels, steering wheels, etc.). If the same stadium is used to host a football game, the faucets can be replaced with indicia representative of football generally or the specific football team (helmets, mascots, footballs, etc.). It should be appreciated that in many embodiments the faucets can be use for promotion as well as advertisement. For the purpose of the present disclosure the terms and concepts are used interchangeably herein.

In some embodiments, faucet configurations are intended to remain constant for an extended period of time. However, in many other contexts, the faucet configurations are intended to be changed often. Some of such embodiments are described above. In such contexts the faucets can be configured to mate with a quick connect base that allows the faucet components to be changed without accessing the underside of the sink or other sanitary structure. For a description of a quick connect base see U.S. Pat. No. 6,328,059 which has been incorporated by reference herein. In some embodiments, the faucet components can be attached to the faucet base without manually shutting off the water. For a description of a base with an integral shut off valve see US 2006/0185076, which has also been incorporated by reference herein.

An example of an embodiment where it is desirable to change the faucet configuration often can be, for example, the faucets at a convention center. If the convention center is hosting a car show the faucets can include indicia relating to motor vehicles (miniature cars, car parts, manufacturer's logos, etc.). If the convention center is hosting a computer convention, the faucets can be changed to embody the corporate logos and devices of the computer manufacturers. Likewise, if the convention center is hosting a convention relating to television programs or media, the faucets may be representative of characters in the television or movie.

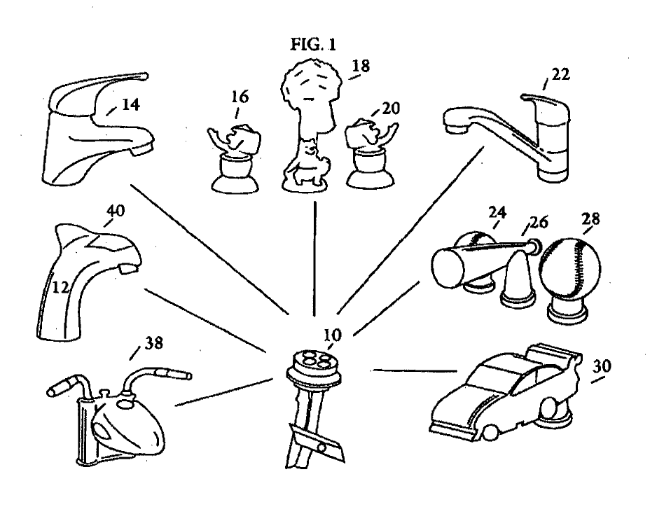

Referring to FIG. 1, an embodiment of the present disclosure is illustrated. The system of the depicted embodiment includes a quick connect base 10. The base is configured to mate with a number of different faucet configurations. A faucet configuration 12 includes a display 40. In one embodiment, the display 40 is a small video screen that can be used to display digital images or video. The video content could in some embodiments be preloaded and in other embodiments be transmitted to the display 40 in real time. In another embodiment the display 40 could be a fixed image or a holographic image. In addition, three specific embodiments of faucets 14, 22, 32, components without advertising indicia are also shown to illustrate that a faucet with advertisement and promotional indicia can be integrated with standard faucets as well.

FIG. 10 shows one possible embodiment 50 of the faucet featuring a video display. This embodiment of the faucet consists of a video display area 52 attached to a baseplate 54 above or containing the spout of the faucet 56. The video display area consists of a video screen 58 (such as, but not limited to, a liquid crystal display) and a small computer (not pictured) encased in a water resistant or water proof screen container 60 that protects the components inside from accidental water exposure while allowing a user to view the video display.

The computer 62 consists of a power supply, processor, local memory storage, a data input and output port (such as, but not limited to, a data cable port, a wireless receiver, or a removable storage device such as a USB drive). Audio and visual programming is transmitted into local storage via the input/output port and stored there until called by the processor to be displayed on the screen.

The video display area is attached at its bottom to the base plate 54 plate with mounting screws so that the video screen area is at angle 66. This angle can be optimized to maintain an effective viewing angle of the screen for users of different sizes or in different positions relative to the video display area.

Underneath or inside the base plate 54 is the spout transfer passageway 68 that directs the water from the water supply to the spout 56. The supply of water is controlled by a powered valve operated by a front facing infrared sensor 70 that detects hand presence (such as, but not limited to, a infrared sensor). The water supply line transfers water from the powered valve, through the faucet fixture 72 to the spout transfer passageway 68.

In this embodiment, the powered valve is connected to the computer 62 via a powered data cable, such as, but not limited to, a powered Ethernet cable. This cord supplies power to the valve and receives data from that valve and infrared sensor 70. In some embodiments, the video display can be incorporated into the body of the faucet spout in a fashion that it displays upward, towards a person using the faucet. In such an embodiment the computer components can be relocated outside of the waterproof/water-resistant container and connected with a data cable if space necessitates.

In these embodiments the display plate is affixed to the top of the faucet, although in alternate embodiments the display can be placed alongside, above, behind, or in other positions proximate to the faucet.

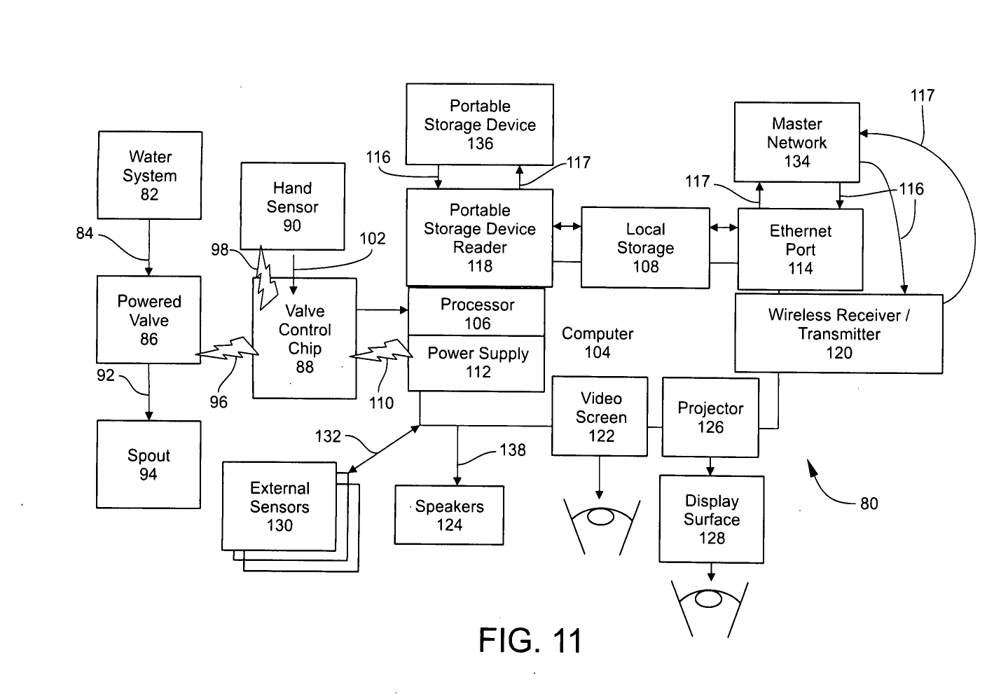

In FIG. 11, a flowchart 80 depicts the flow of information, power and water in a faucet featuring a video display. Water is supplied to the faucet from a typical faucet supply water system 82 through the input of the powered valve 84. The flow of water is controlled by a powered valve 86 that is controlled by the valve control chip 88. The valve control chip powers hand sensor 90 through power cable 98 and receives sensor data 102 if the sensor detects the presence of hands.

When hand sensor 90 senses the presence of hands beneath the spout of the faucet it sends a signal to the valve control chip 88 which supplies power 96 to the valve 84 allowing the flow of water through the spout transfer passageway 92, and out the faucet 94. At the same time the valve control chip 88 sends the hand sensor data 102 to be processed by the local processor 106 and stored in local storage 108 inside computer 104.

The valve control chip 88 receives power 110 via the power supply 112 of the computer 104, which receives power from a power source 113 such as, but not limited to, a wall socket or a battery.

The computer 104 receives content and instructions 116 through an Ethernet port 114 and stores the content into local storage 108. Alternatively, the computer can receive this content through a portable storage device reader 118, a wireless network receiver/transmitter 120, or through power line communications via the power source 113.

The wireless network receiver/transmitter 120 transmits and receives information in one or more forms including, but not limited to, WiFi signals, radio frequencies, near field communications, microwave signals, or infrared signals.

In some embodiments, the wireless network receiver/transmitter 120 is capable of broadcasting and receiving signals to and from mobile devices such as, but not limited to, cellular phones, tablets and mobile personal computers. This additional capability allows mobile device users to access or input additional information in the faucet computer 104 or the master server 134.

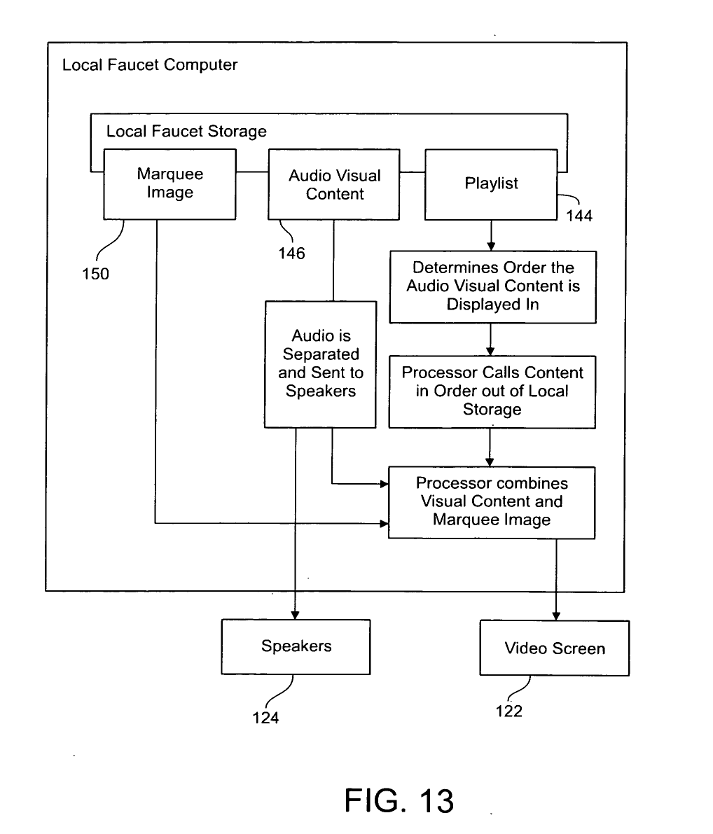

As demonstrated in the flowchart contained in FIG. 13 when the video display 122 is operating, the processor 106 (not pictured) examines the playlist file 144 and determines what audio visual content 146 to display. The processor 106 calls that content out of local storage 108 in the order defined by the playlist. If necessary the audio content is separated from the visual content and then transmitted to the speakers 124. The visual content is combined with the marquee image and transmitted to the video screen 122 where it is displayed to a user,

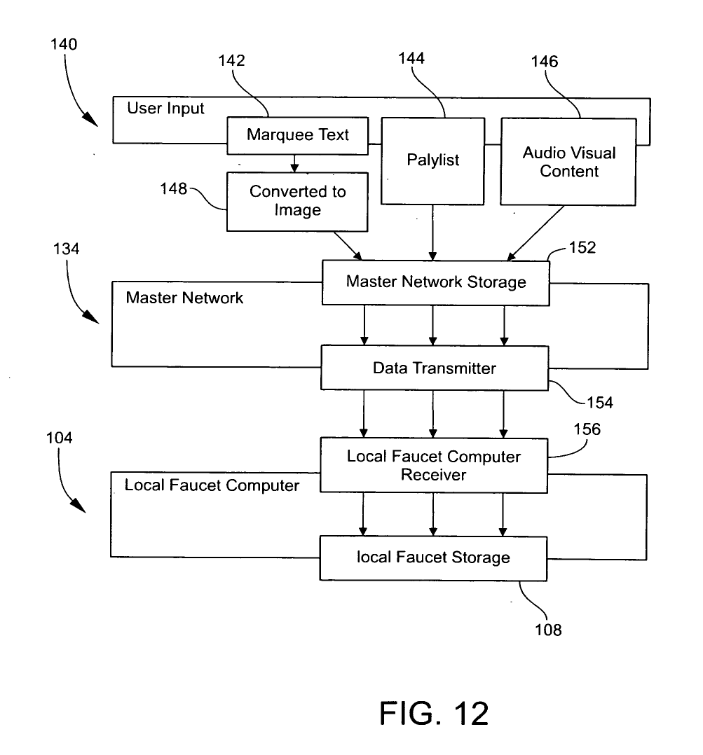

In FIG. 12 a flowchart demonstrates the flow of content from user input 140, to the master network 134, onward to the local faucet computer 104. User input is gathered via a graphical user interface (not pictured) that can be located on the Internet, allowing users to manipulate the programming on the faucets from a wide variety of locations. The user generally inputs three types of information into the master network: the marquee text 142, the playlist order 144, and the audio/visual content 146. The marquee text 142 consists of a typed message that will scroll across a portion of the screen. The playlist order 144 contains information about the programming and scheduling of content to be displayed on the faucet. The audio/visual content 146 consists of a digitally encoded series of files containing auditory and/or visual information (such as, but not limited to, encoded digital video files, sound files, or image files) that can be displayed on the video screen An automated process 148 converts the marquee text into a marquee image 150 (such as, but not limited to, a bitmap image) for later processing. These three types of content are then automatically transmitted to the master network 134 where it is placed into the master network storage 152.

Alternate embodiments of the faucet featuring a video display are capable of receiving and displaying live video signals through the master network 134.

In the present embodiment, the master network automatically transfers the new content to the faucet via a data transmitter 154 such as a network port or a wireless receiver/transmitter. In alternate embodiments, the user can input and modify a schedule for automatically updating the faucet.

The faucet computer 104 receives content from a master server via a network over a data receiver 156 such as, but not limited to, an Ethernet port or a wireless transmitter/receiver.

An alternate embodiment featuring a video display would contain a portable storage device reader (such as, but not limited to, a USB drive or an SD card reader) to alter programming instead of a connection to a network.

An alternate embodiment featuring a video display would contain a rear-facing projector 126 instead of an internal video screen display. The projector continues to receive input from the internal computer and displays that content on a surface 128 behind the faucet such as a wall or mirror so that a person using the faucet would be facing the display. Audio information would be transmitted to the speakers 124 as in the previous embodiment.

An alternate embodiment featuring a video display would feature a touch sensitive video display capable of displaying information and collecting input selections made by touching areas of the touch sensitive video display. A touch sensitive video display allows the touch screen user to access information on demand from the faucet, such as selecting and replaying individual programming elements, or accessing additional information about programming elements. The faucet computer 104 displays information on the touch sensitive video display and interprets the selections made, revising the display to reflect the faucet user's selections or additional information. Statistics on use of the touch screen can be recorded and saved into local storage 108 or transmitted for storage to the master server 134.

An alternate embodiment featuring a video display would contain an array of sensors 130 (such as, but not limited to, sound sensors, infrared sensors, motion detectors, or eye tracking sensors) to determine faucet usage statistics, advertising impressions, and register the presence, or lack thereof, of human beings. The sensors communicate this information 132 to the computer where this data would be stored on the faucet in local storage 108 until it is transmitted to a master network 134 via the Ethernet port 114 or the wireless network receiver transmitter, or removed via an external storage device 136.

An alternate embodiment featuring sensors could alter programming and adjust the operations of the faucet device based upon incoming sensor data 132. Sensors such as, but not limited to, sound sensors, infrared sensors, eye-tracking sensors, motion-tracking sensors, faucet flow sensors and other remote and connected sensors collect data regarding faucet usage, advertising impressions, human proximity, room presence and viewing statistics. This device is maintained in local memory storage 108 until it is transmitted to the master network 134.

Some embodiments featuring sound sensors may trigger content, information delivery, or other features upon activation or receiving certain predetermined sound input. This could allow for faucet users to request or trigger functions, information or services using speech activation.

Some embodiments of a faucet featuring a video display may synchronize playback automatically so that all faucets in a room display the indicia in tandem utilizing synchronized local clocks, or using timestamp information provided by the master network 134.

One embodiment of a faucet 36 with unique artistic qualities absent advertising indicia is also shown to illustrate that the system of the present disclosure can be used with non-standard faucets that are not necessarily designed for advertisement. The faucet 36 may be used in context where new and changing faucet components are desirable for other reasons other than for traditionally advertisement purposes. For example, artistic faucets like faucet 36 may be desirable in an art museum where the faucets can be changed to complement the displayed exhibits.

Embodiments of faucets 16, 18, 20, 34 that included indicia representative of television or movie characters are also shown. In the faucet configuration referenced by numbers 16, 18, and 20 represent a set of faucet components that are configured to work together. Faucet component 16 controls the flow of hot water, faucet component 20 controls the flow of cold water, and faucet component 18 dispenses the water. The depicted embodiments can, for example, be particularly desirable at a child care facility, a retail store selling Disney related merchandise, or a theater featuring a Disney movie. As illustrated above, the same faucets used in different context can have different effects. The method of advertising described herein is intended to encompass a method of general promotion. It should also be appreciated that the system and apparatus provided herein are intended to be directed at the devices notwithstanding the context or purpose for which the faucets are used.

Sports related faucet embodiments 24, 26, 28, 30 are also illustrated. The embodiment of the set of faucet components 24, 26, 28 are intended to work together. Faucet components 24, 28 regulate flow and temperature and faucet component 26 directs the flow. In the depicted embodiment the theme is broadly sports, more narrowly baseball, and even more narrowly baseball equipment. It should be appreciated that in an alternative embodiment, the theme could also be team specific, for example, it could represent the mascot and colors of the team or even a representation of key players on the team. In should be appreciated that many other alternative embodiments are also possible. For example, an alternative embodiment may embody a golf theme where the faucet is in the shape of a driver and the regulating component(s) are in the shape of putters or other golf related equipment.

The faucet 30 illustrates yet another embodiment that is sports related. The depicted embodiment can be desirable, for example, in a restroom at the race track or hotel in the areas that are hosting the race. In one embodiment of the present disclosure the faucet systems are use in a hotel. The hotel collects information regarding the expected guests and customizes the faucets in the room based on the collected information of the guest's characteristics. For example, the hotel may determine that players from a particular professional basket ball team will be staying in particular rooms of the hotel. The hotel can customize the faucets component in those rooms to include basketball related indicia. In some embodiment, the indicia can include team specific indicia (e.g., team colors, team numbers, or team mascots). The hotels could alternatively identify that it will be hosting a group of doctors who are in town for an annual convention. The hotel could sell the advertisement space of its faucets to medical device or pharmaceutical companies who want their advertisements to be displayed on the faucets in the hotel rooms.

It should be appreciated that similar custom promotion and advertisement can be applied in many other contexts outside of the hotel context. In some embodiments the faucets can include an audio context as well. For example, the faucet could be configured to provide a message to the faucet users such as instruction to a child to brush his or her teeth. The audio content could be an advertisement/promotional in nature. For example, the faucets in a casino may announce wins at certain slot machines in real time. In should also be appreciated that some embodiments may include more than one theme in a single set of faucet components (e.g., baseball regulator components with a coca cola bottle shaped dispenser).

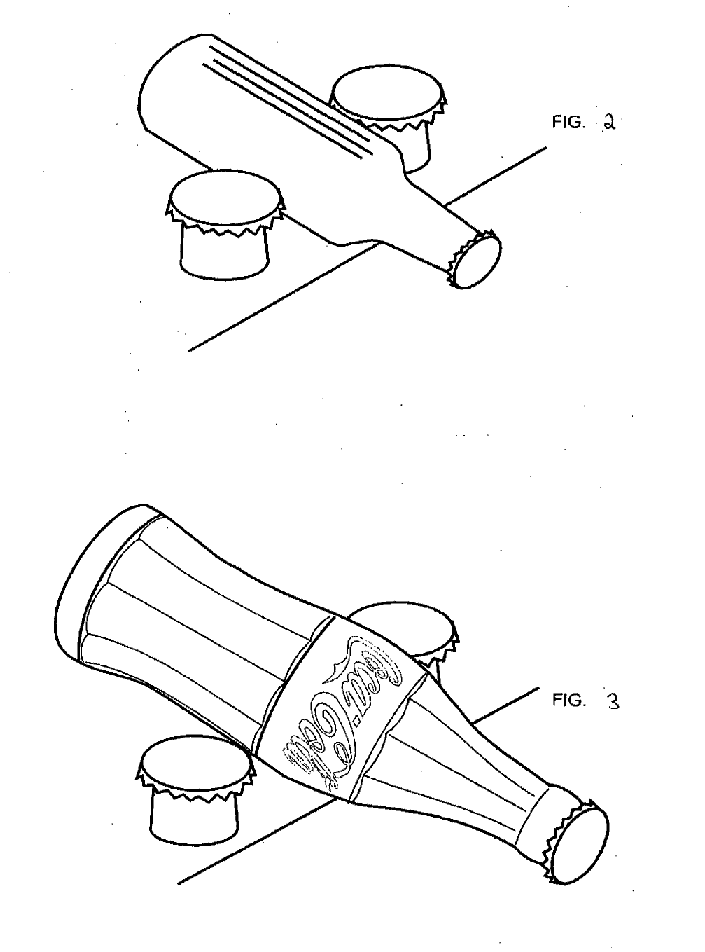

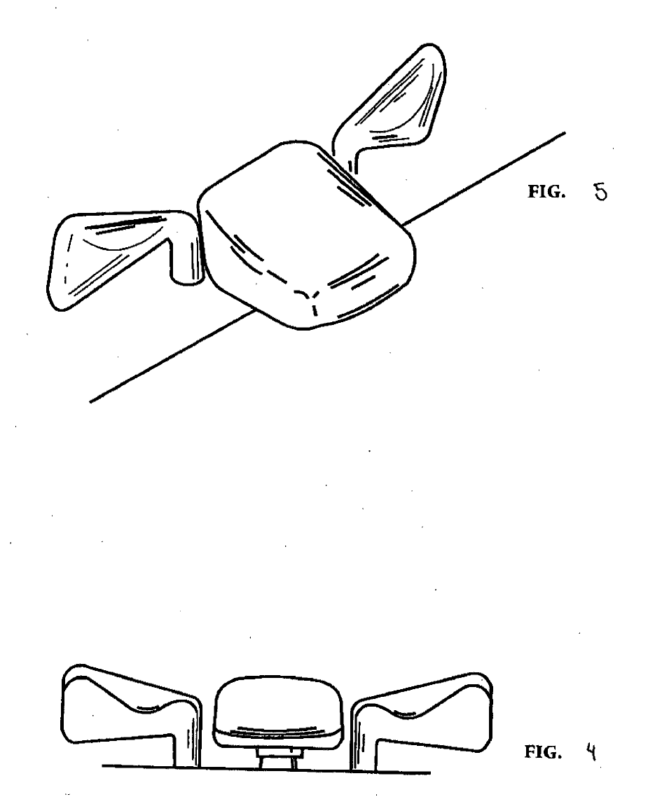

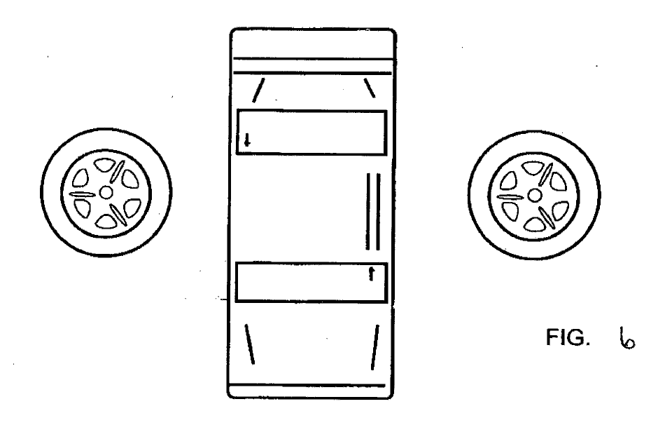

Referring to FIGS. 2-7 additional views and alternative embodiments are illustrated. FIG. 2 shows an embodiment where the faucets embody indicia relating to beer. FIG. 3 shows an embodiment where the faucets embody indicia relating to a particular type of soft drink. FIGS. 4-5 show embodiments including indicia relating to golf equipment (irons/woods) as well as corporate logos.

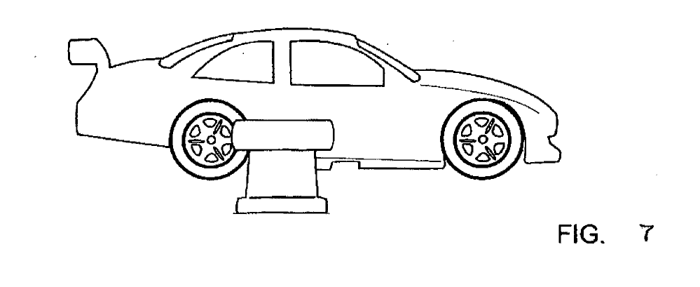

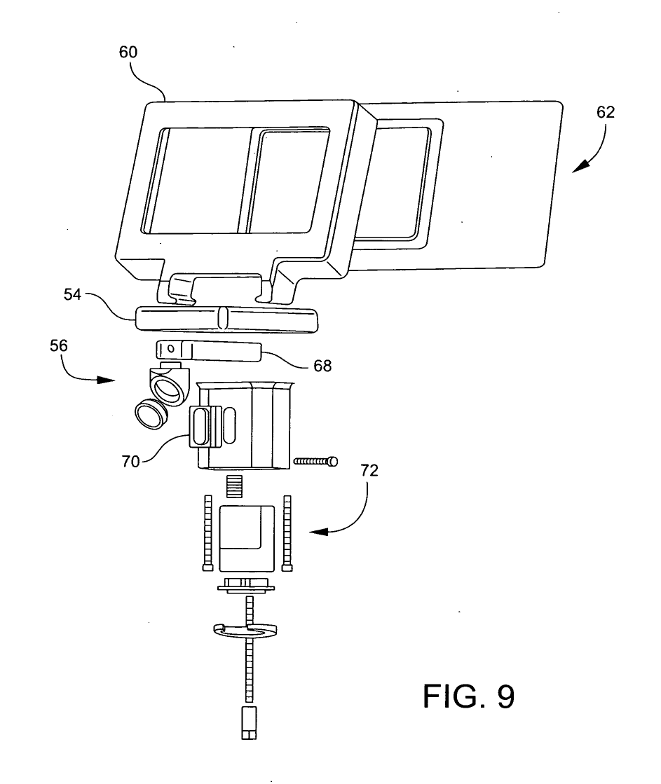

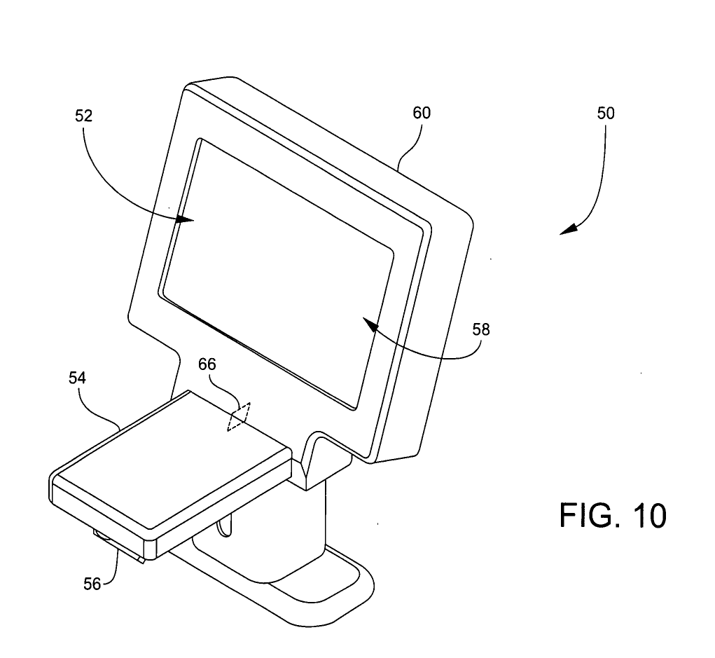

FIGS. 6 and 7 further illustrate an embodiment include indicia relating to a race car. It should be appreciated that many other embodiment are also possible.

In yet another embodiment, the faucet 30, includes an integral display screen that is used to display advertising.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

1. A method of advertising comprising the step of connecting a faucet component that includes advertising indicia thereon to a sanitary fixture.

2. The method of claim 1, further comprising selecting the faucet component based on the advertising indicia and based on information about those who are expected to use the faucet.

3. The method of claim 2, further comprising the step of collecting information about the expected faucet users.

4. The method of claim 2, wherein the sanitary fixture is a sink, the advertising indicia embodies a sports related theme, and an expected user of the faucet is a hotel guest.

5. The method of claim 2, wherein faucets with advertising indicia that embody images associated with a specific organization are located in the hotel room reserved for a member of the organization.

6. The method of claim 5, wherein the specific organization is a sport team and the indicia includes the team logo.

7. The method of claim 5, wherein the specific organization is a corporation and the indicia includes a corporate logo.

8. The method of claim 1, wherein sanitary fixture is a sink and wherein the faucet is connected to the sink without accessing an underside of the sink.

9. The method of claim 8, wherein the faucet is connected to the sink without manually shutting off the water flow to the sink.

10. The method of claim 1, wherein the advertising indicia resemble miniature recognizable objects.

11. The method of claim 10, wherein the advertising indicia are faucet components shaped to resemble sporting equipment.

13. A faucet for advertising comprising: a water dispensing component including an inlet and an outlet, a water regulating component configured to regulate the flow of water and the temperature of the water that is dispensed from the water dispensing component, wherein the dispensing component is configured to resemble a first recognizable object and wherein the regulating component is shaped to resemble a second recognizable.

14. The faucet of claim 13, wherein the dispensing components are configured to be connected to a quick connect base member accessible from on an upper surface of a sink.

15. The faucet of claim 13, wherein the first and second objects resembles sport related objects, cartoon characters or vehicle components.

16. The method of claim 1, wherein:
a. The advertising indicia are a series of visual and/or audio programming content displayed, through the means of a local computer connect to the faucet, on a video screen located on top of or adjacent to the faucet;
b. The order the visual and/or audio content is displayed in is determined by a playlist contained in the local computer;
c. The visual and/or audio content and the playlist is transmitted to the local computer from a master server through means of a network;
d. The programming can be altered remotely through the network without interrupting the display by dynamically restructuring the order of the playlist as new content is downloaded.

17. The method of claim 16, except as to part c, wherein instead of a network, the programming content is transmitted to the local computer by way of a removable storage device.

18. The method of claim 16, except as to part a, wherein instead of a video screen, the visual content is displayed via a projector onto a flat surface.

19. The method of claim 16, wherein:
a. A marquee is displayed below or above the video display;
b. The marquee is transmitted to the local computer from a master server through means of a network and combined with the visual content locally prior to display.

20. The method of claim 16, wherein one or more sensors detect and record the presence of human beings, the number of advertising impressions and related data and store this data into the local computer storage until it can be transmitted over the network or through a removable storage device.
